(19) United States
(12) Patent Application Publication
(10) Pub. No.: US 2014/0373407 A1
(43) Pub. Date: Dec. 25, 2014

(54) SELF-CONTAINED VARIABLE DISPLAY DEVICE FOR MARKING AN ARTICLE

(71) Applicant: EXAQTWORLD, Joinville Le Pont (FR)

(72) Inventors: Alain Favier, Nogent Sur Marne (FR); Tamas Lodi, Budapest (HU)

(73) Assignee: EXAQTWORLD, Joinville Le Pont (FR)

(21) Appl. No.: 14/376,160

(22) PCT Filed: Feb. 4, 2013
(86) PCT No.: PCT/FR2013/050234

§ 371 Date: Aug. 1, 2014

(30) Foreign Application Priority Data
Feb. 3, 2012 (FR) 1251051

(51) Int. Cl. G09F 11/18; G09G 5/36; G09F 11/22

(52) U.S. Cl. CPC G09F 11/18; G09F 11/22; G09G 5/36; G09F 2011/0009
USPC 40/518; 345/211

(57) ABSTRACT

A device for marking an article with a view to identifying same includes an information display area, a medium for storing the information to be displayed (26), a programmable clock (42), an electrical power supply system (44), a selection element (38, 40, 40a, 22b) for selecting information from the storage medium in order to display same in a display area and an element for attaching the device to the article or packaging thereof, wherein the selection element is enabled at one or more moments programmed into the programmable clock.

The invention concerns a device for marking an article in order to identify it. The invention more particularly concerns a device for protecting an article against theft, notably shoplifting.

To combat shoplifting effectively and more particularly to combat the theft of certain products such as textile products (shirts, sweaters, underclothes, pants, lingerie, ties, socks, t-shirts, dresses, coats, hats, shoes, polo shirts, skirts, etc.) retailers use known security tags (also known as “EAS tags”). The security tags trigger a security portal or a surveillance system disposed at the access points (entrances/exits) of a point of sale such as a supermarket or hypermarket, a store, a specialist store, a duty free store, a department store, a museum, a video club, a pharmacy, and any other store or entity that sells or displays self-service articles that can be stolen or taken without authorization.

These tags generally comprise two parts:
a body that contains a locking system and an active or passive unit that triggers the detection antennas or portals commonly installed at the access points of stores,
a spike that passes through the article to be protected (for example the fabric of a garment) or the cardboard or the plastic of a blister pack.

Fitting these security tags to the articles to be protected takes the staff of the stores in which these articles are sold a long time.

Moreover, stores, notably those that sell textile articles, devote a great deal of time and incur high labor costs in labeling and relabeling the articles on sale, notably during sales. In fact, at least three different color labels or marking devices are generally added to the price ticket with legends of the type: 1^{st} mark-down (−20%), 2^{nd} mark-down (−30%), 3rd mark-down (−50%). Also added are promotional labels of the “Happy Holiday”, “Happy New Year”, “Happy Valentine's Day”, etc. type as a function of various sales events, promotional campaigns, etc.

There is known from the document WO 2012/013899 a device for marking an article in order to identify it. This device includes an information display area, a medium for information to be displayed, an electrical power supply system, means for selecting information from the medium to display it in the display area and means for fixing the device to the article or its packaging.

According to the teaching of the above document, information from the medium for information to be displayed is selected either manually, using an external tool, or remotely, using a receiver unit in the device and receiving activation information from an external source.

Although the above device is satisfactory, it nevertheless has some limitations.

In fact, at some times of year, it is necessary to change the display of certain article marking devices of the type described above by selecting new information from the information medium in order to display it (reductions applied for sales or particular promotional operations, display of specific information relating to one-off events in the year such as the New Year's holiday, Valentine's Day, Mothers' Day, etc.).

Not all article marking devices are necessarily affected by this change of display. For example, it is then necessary to select the information to be displayed on several hundred or several thousand marking devices fixed to articles on sale in a large store among the tens or even hundred and thousands of devices present in the store.

If this task must be effected manually using an external tool, considerable labor and time are required.

On the other hand, if the task is effected remotely using an activation information receiver unit as described above (there is a receiver unit in each marking device fixed to an article), this is not without a few problems.

In fact, before an activation signal is transmitted remotely to the marking devices concerned, it is first necessary to identify those devices.

This task is not easy in a large store where electromagnetic interference phenomena may occur that are liable to interfere with the preliminary phase of identifying the marking devices and the subsequent phase of sending the activation signal or signals to the identified devices.

Errors and/or malfunctions can therefore occur during these phases, as well as human errors on the part of the staff of the store responsible for carrying out these phases.

Some or all of these problems are exacerbated if the store occupies a number of buildings located side by side or virtually side by side.

The invention proposes to eliminate at least some of the aforementioned disadvantages by proposing a device for marking an article to identify it, the device including an information display area, a medium for information to be displayed, an electrical power supply system, means for selecting information from the medium to display it in the display area and means for fixing the device to the article or its packaging, characterized in that the device includes at least one programmable clock, said selection means being adapted to be activated at one or more times programmed in the programmable clock.

It is therefore possible to vary the information to be displayed (image(s), photograph(s), drawing(s), text(s) and/or combinations of one of these elements in the display area, which is a display window, for example) by selecting information from the medium and replacing that already being displayed by that selected.

This task is effected autonomously by the marking device alone, without external human intervention (tools, sending of signals, etc.), without transmitting signals liable to suffer interference and without it being necessary to identify the device before changing the display.

The staff of the store is therefore no longer burdened with tasks that are time-consuming and prone to error.

The management of this type of marking device and of changing the display is therefore greatly simplified.

Accordingly, a marking device of this kind associated with an article for sale, for example fixed to it, enables the customers of a store to be shown the required commercial information at time periods that are related to particular sales events (New Year's holiday, sales, Mothers' Day, etc.). The display of such information therefore varies on command as a function of the previous programming of the clock without the staff of the store having to intervene. As a function of the dates, and possibly times, programmed in the clock (programmed schedule), the selection means are activated automatically and autonomously to select information corresponding to said dates and times for display or viewing. The operation of changing what is to be displayed or viewed is therefore more reliable than in the prior art.

For example, information is selected from the marking device relating to a particular operation promoting the article, such as a percentage reduction on the selling price of the article, as a function of the required promotional campaign.

The information medium (e.g. tape or film, disk, memory or other storage means for storing digital information, etc.) includes a plurality of sets of information, for example, and in the chosen example a plurality of different reduction percentages that are selected by the staff of the store and displayed after selection by the staff.

A marking device associated with an article can therefore display a 20% reduction one day and through a simple operation by the staff of the store a 30% reduction the next day.

The variable display device in accordance with the invention makes it unnecessary to change the marking device to display other information.

It will be noted that the marking device in accordance with the invention may optionally include means for identifying the device and also means for identifying the article with which it is associated (to which it is fixed). Such means take the form of an RFID chip, for example. Such means are used for purposes other than changing the display, for example.

In accordance with one particular feature, the device includes a control circuit that activates the means for selecting information from the medium at the predetermined time or times.

This circuit is itself activated or “awoken” automatically by the clock as soon as a previously programmed time event (date and possibly time) occurs. This saves energy.

In accordance with one feature, the information medium is a medium including a plurality of printed information regions, the information selection means being adapted to be activated to select one or more information regions to be displayed in the display area. It will be noted that the other information regions that have not been selected are not visible (outside the display area) and may be masked by an element of the device, for example.

Thus not all of the information carried by the medium is visible from outside the marking device, the selection means making it possible to display only the required information (i.e. information the display of which has been programmed).

In accordance with one possible feature, the medium is an elongate tape comprising a plurality of printed information regions arranged side by side in the lengthwise direction of the tape, said tape being wound around two spaced members each of which is adapted to turn about its longitudinal axis to scroll information regions of the tape in the display area (for example facing at least one transparent part of a display window).

Such an arrangement makes it possible to make the marking device particularly compact.

The tape or film carrying information is therefore similar to a gelatin silver photographic film used with pre-digital cameras (analog cameras).

The information to be displayed is selected in a particularly simple manner by rotating the members supporting the tape.

The members supporting the tape are rollers, for example.

It will be noted that the device includes means for turning the members supporting the tape. These means are generally part of the means for selecting the information to be displayed.

In accordance with one possible feature, the tape is interchangeable.

The staff of the store can therefore replace the tape or film carrying information, or more generally the information medium if it is interchangeable, and thus load new information into the device.

The replacement of the tape alone that resembles replacing a consumable is then a more economic operation than replacing the device itself. Moreover, the tape can be changed when the device is fixed to the article.

For example, the tape or film carrying information may itself be mounted on a support (e.g. made of plastic) and it is the combination of the tape and its support that will be replaced like toner cartridges in printers or gelatin silver photographic film.

In accordance with another possible feature, the marking device includes at least one element adapted to receive activation information for activating the selection means.

In this variant embodiment, the selection means are not activated in a programmed manner thanks to the clock incorporated in the device but on receiving information (an activation signal) transmitted remotely, for example by radio or infrared beam. The received information enables activation of the selection means and therefore selection of the information to be displayed as required.

The staff of a store can therefore very easily send information by radio or by infrared beam from a fixed or mobile control station to vary the information displayed by one or more marking devices whether present or not on articles for sale in the store.

It will be noted that this variant embodiment represents an additional function of the device, over and above that made possible by the clock, in order to be able to vary at times not foreseen at the time of programming the clock the information to be displayed or viewed.

In accordance with another possible embodiment, the medium is a disk having on one face a plurality of printed information regions arranged side by side in different angular sectors of the face of the disk. The disk or a display window of the display area is for example able to turn about its center to bring into geometrical corresponding relationship information regions and the information display area (for example at least one transparent portion of the display window).

Movement of the disk relative to the display window enables one or more required information regions to be brought face to face with a transparent window portion.

It will be noted that the device includes means for turning the disk or the window relative to one another. These means are generally part of the means for selecting information to be displayed.

In accordance with another possible feature, a cache is positioned over the disk and includes an opening facing an information region to be displayed.

A non-open (opaque/non-transparent) part of this open cache masks the non-selected information.

It will be noted that the opening serves as a display window.

In accordance with one possible feature, the cache is able to turn about its center so that the opening is brought into geometrically corresponding relationship with an information region of the disk to be displayed.

The function of selecting information to be displayed is therefore performed by rotation of one of the aforementioned elements. Rotation means are provided for turning the cache relative to the disk. These means are generally part of the means for selecting information to be displayed.

Non-selected information is concealed by the opaque window portion or by the non-open portion of the cache, as applicable.

In accordance with one possible variant embodiment, the general shape of the display window substantially corresponds to that of the disk and includes, on the one hand, a transparent portion in the shape of an angular sector for displaying the selected information region or regions and, on the other hand, a non-transparent portion masking the other, non-selected information regions.

In accordance with one possible feature, the selection means include at least one motor connected to the information medium, for example to the tape carrying information and more particularly to the members supporting this tape.

The activation of said at least one motor at one or more predetermined times makes it possible to select information to be displayed and to display it in the display area.

Said at least one motor is for example activated by a control circuit that is itself activated or “awoken” by the programmed clock.

In accordance with one possible feature, said at least one motor is a stepper motor enabling precise adjustment of the selection of information and, for example, the scrolling movement of the tape carrying information or the rotation movement of the disk or of the display window or the cache.

In accordance with one possible feature, said at least one motor is connected to the information medium via a gear mechanism.

In accordance with another possible embodiment, the information display area is a digital display screen.

In this embodiment, the digital display screen is an LCD type screen for example and the information medium takes the form of an electronic memory for example or some other means for storing information.

The means for selecting information to be displayed that is in the information medium, such as a memory or some other type of information storage, are activated as a function of events or times programmed in the clock. The information is therefore extracted from the medium and transmitted to the display screen.

The selection means include for example a microprocessor which, as a function of the programmed clock (occurrence of predetermined time(s)), selects data in the medium, transfers it to the screen and displays it. A separate control circuit may optionally be placed between the clock and the microprocessor.

In accordance with one possible feature, the electrical power supply system includes at least one cell or battery, for example a “button” type cell.

In accordance with one variant embodiment a light sensor, for example disposed on the device, is provided for charging the cell or battery.

Alternatively, the light sensor supplies electrical energy directly to the clock following conversion from luminous energy, therefore enabling cells or batteries to be dispensed with.

It will be noted that stores are particularly well lit, which favors the use of a light sensor.

In accordance with one possible feature, the marking device includes an information display window at least a portion of which window is transparent and constitutes the information display area so that selected information from the medium is visible through said at least one transparent window portion.

This window also protects the information carried by the medium (mechanical protection, for example against wear, dirt, dust, splashed liquids, moisture, etc.).

It will be noted that to the extent that the printed regions of the information medium are protected, notably against wear, the material of the printed region of the medium may be chosen to lend itself in a particularly satisfactory manner to processes that produce varied, complex printing calling on numerous colors and of high quality.

It is therefore no longer necessary to suffer the limitation to printing techniques producing printing that is resistant to wear, for example pad printing type techniques.

Such protection therefore makes it possible to lengthen considerably the service life of the inscriptions (text, drawings) incorporated in the printed regions.

The window therefore includes at least one transparent portion for viewing the selected information and may for example include another, opaque portion for masking non-selected information regions of the medium.

In accordance with one possible feature, the marking device includes a casing forming an open housing to receive the information medium.

In accordance with another possible feature, the display window is disposed on the casing so as to close the housing.

The design of this arrangement is particularly simple.

In accordance with one possible feature, the marking device includes a spike extending out of it. For example, the spike cooperates with a complementary device to assemble and lock the two devices to each other.

The spike constitutes means for fixing to the article to be protected and passes through the latter or its packaging before cooperating with the complementary device.

The spike is generally carried by a complementary device and insertion of the spike into the housing (which carries means for locking the spike) enables the two devices to be assembled together in a locked position.

The means for locking the spike prevent withdrawal thereof after its insertion.

In accordance with one possible variant embodiment, the marking device includes means for locking a spike intended to be inserted in the casing.

It will be noted that the features of the marking device referred to above also apply if the spike is carried by the complementary device and not by the marking device.

In accordance with one possible feature, the spike of the marking device extends out of the casing in the direction away from the display window.

The spike is therefore intended to be inserted in a complementary device to enable assembly of the two devices.

In accordance with one possible feature, the window is disposed with one of its faces referred to as the internal face facing a face referred to as the internal face of the information medium carrying information, the spike extending from the internal face of said window in the direction of the internal face of the medium and passing through the latter in order to project relative to a face called the external face of the medium externally of said medium.

In accordance with one possible feature, the marking device includes a head having two opposite faces, an internal face and an external face from which the spike extends, the information medium being disposed between the internal face of the head and the display window.

In accordance with one possible feature, the marking device and/or the complementary device includes at least one active or passive unit that is able to emit electromagnetic waves toward the exterior of the device or to receive same, therefore conferring on the device a function of protecting the article against theft and/or a function of identification and/or traceability and/or storage or exchange of information. An RFID chip can provide one or more of these functions, for example. It will be noted that this feature applies independently of the device including the spike of the means for fixing it to the article and assembling and locking the two devices to each other.

The unit or units able to cooperate with a complementary antitheft detection system (for example an antitheft portal) and to trigger an alarm are therefore accommodated in at least one of the two devices.

The unit carried by the device or devices is for example a passive unit that receives electromagnetic waves when it is located in the vicinity of the complementary detection system.

One such passive unit is a resonant electric circuit, for example, that in a known manner is caused to resonate by the action of exciting waves emitted at the resonant frequency of the circuit.

The unit or units able to cooperate with a complementary antitheft detection system and to trigger an alarm are alternatively one or more active units emitting electromagnetic waves, whether or not this is in response to electromagnetic waves received from the complementary system.

In the general configuration of the invention (information display area, clock, electrical power supply, information medium, information selection means and fixing means), the means for fixing the device to the article may take the form of members for gripping the article (without passing through it), for example a clamp, that can be actuated to clamp/unclamp the article from a control unit. The clamping members and the control unit are part of the marking device and are not separate parts.

The invention further consists in a system for protecting an article against theft (e.g. a security tag) that includes a marking device as briefly described above.

In accordance with one possible feature, the protection system includes a complementary device and means for assembling the two devices to each other and locking them in the assembled position.

It will be noted that the protection system in accordance with the invention can include only one part, namely the marking device provided with means for fixing it to the article such as one or more clamping members such as a clamp (to be fixed to an article or packaging, for example, that cannot have a spike passed through it) or two parts of which one is the aforementioned marking device and the other a complementary device. The two parts are fixed to each other and to the article by fixing means carried by one part or the other.

If the protection system includes two devices, they are used in cooperation with the article to be protected and grip it, for example, so that once assembled and locked together they cannot be separated from the article.

The only way to remove the protection system from the article is then to use means for unlocking the two devices conventionally installed at the checkouts of the store in which the article is offered for sale.

It will be noted that the means for fixing the device to the article or its packaging (for example a spike passing through the article or its packaging) may be either on the marking device or on the complementary device.

In accordance with one variant embodiment, each of the devices carries part of the fixing means.

In accordance with one feature, either the marking device or the complementary device is equipped with a spike intended to be inserted into the other device, the latter including means for locking the spike to prevent its withdrawal in order to lock the protection system to the article or its packaging.

The other device includes an orifice for inserting the spike in this other device, for example, and the locking means prevent withdrawal of the spike after its insertion.

The invention further consists in an article, for example an article that is for sale, equipped with a marking device or an antitheft protection system (the device or the system is fixed to the article) and briefly described above and which has at least one of the features described above.

Other features and advantages will become apparent in the course of the following description, which is given by way of nonlimiting example only and with reference to the appended drawings, in which:

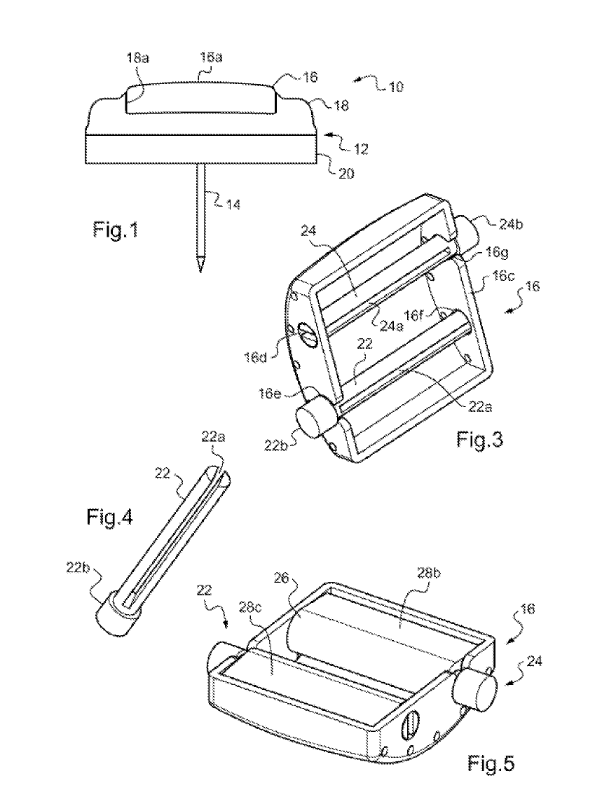

FIG. 1 is a diagrammatic view of an assembled marking device of a protection system in accordance with a first embodiment of the invention;

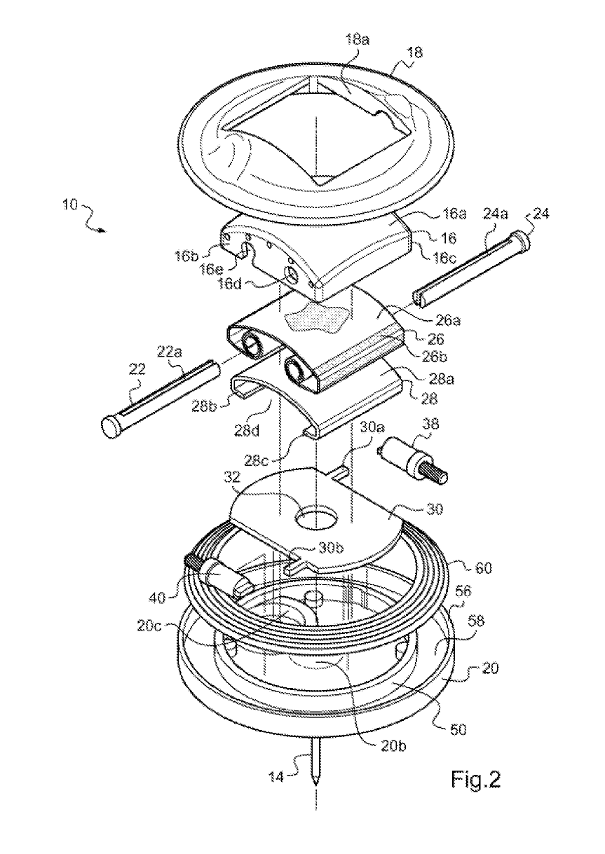

FIG. 2 is an exploded perspective view of the device from FIG. 1;

FIG. 3 is a perspective view from below of a cap incorporating two rollers;

FIG. 4 is a perspective view of one of the rollers from FIG. 3;

FIG. 5 is a perspective bottom view of the cap from FIG. 3 incorporating an information medium and its support part;

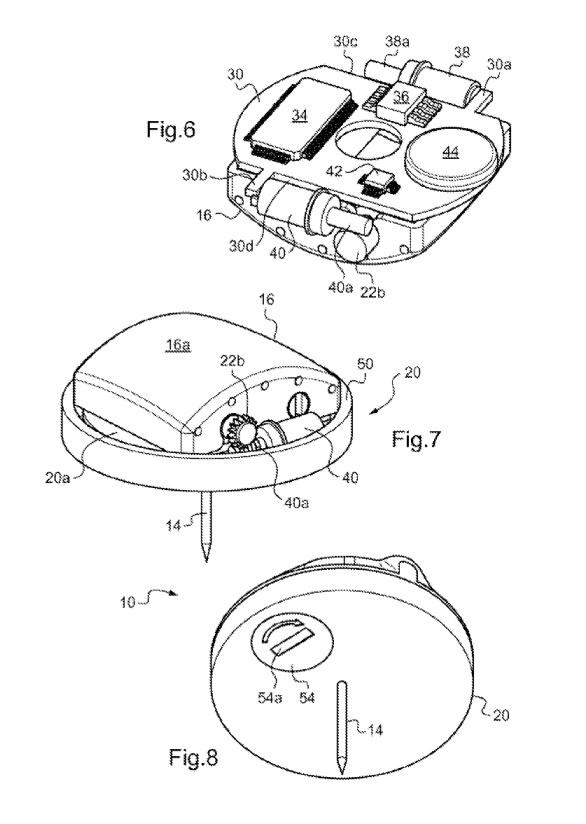

FIG. 6 is a bottom view showing some of the internal elements of the marking device from FIG. 2 when assembled;

FIG. 7 is a diagrammatic partial view showing the cooperation of a motor with one of the rollers integrated into the cap from FIGS. 3 and 5;

FIG. 8 is a perspective bottom view of the assembled device;

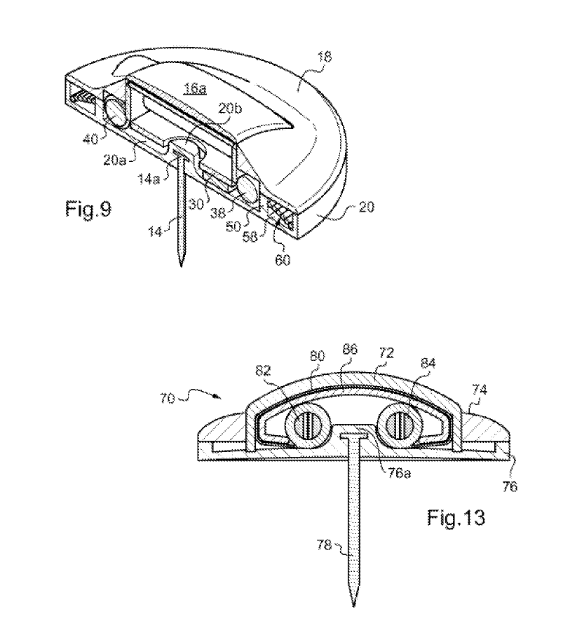

FIG. 9 is a diagrammatic perspective view in axial section of the marking device from FIGS. 1 to 8;

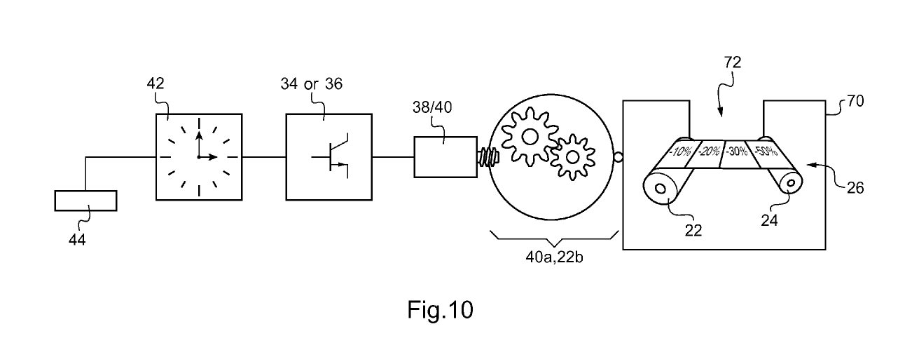

FIG. 10 shows the elements of the system for processing the mode of activation of the programmed variable display;

FIG. 11 is a diagrammatic view to a larger scale of a printed tape 26 inside a casing 70;

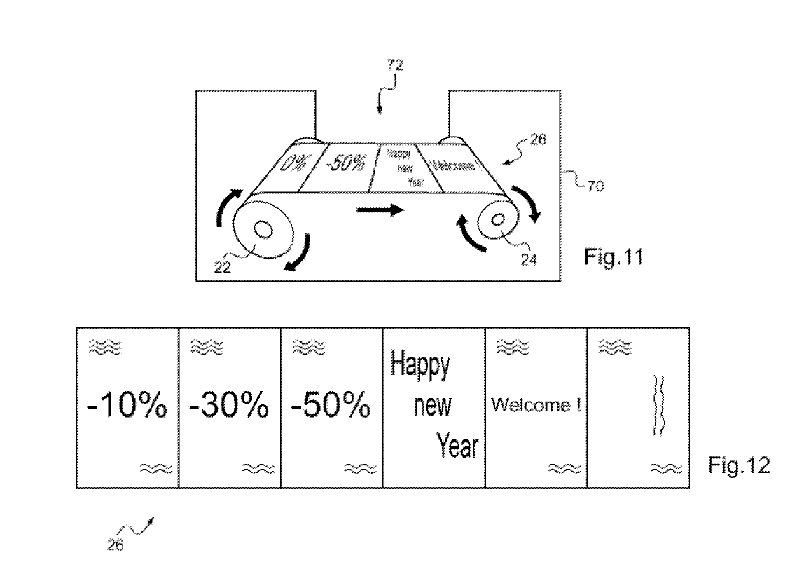

FIG. 12 is a diagrammatic view to a larger scale of the printed tape 26 from FIG. 11;

FIG. 13 is a diagrammatic view in axial section of a marking device of a protection system in accordance with a second embodiment;

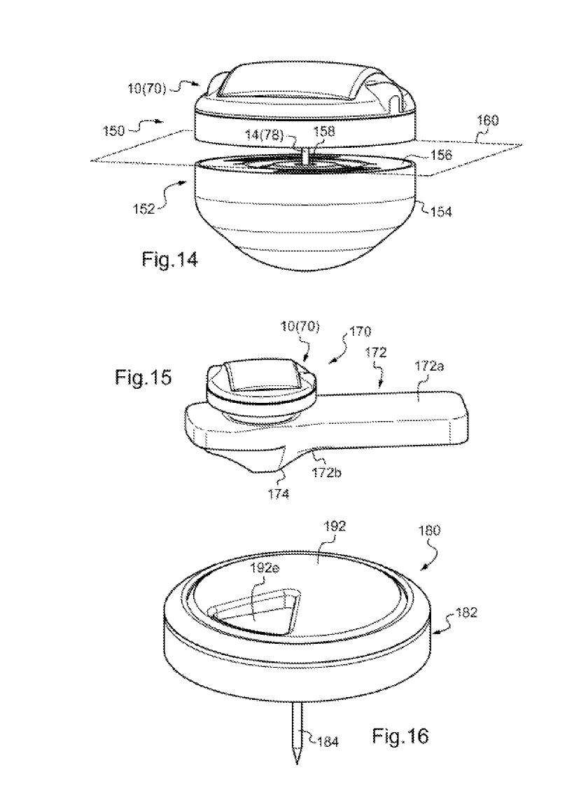

FIGS. 14 to 15 represent two examples of a system for protecting an article against theft incorporating a marking device in accordance with either of the aforementioned embodiments;

FIG. 16 is a diagrammatic general perspective view of a marking device of an assembled protection system according to a third embodiment of the invention;

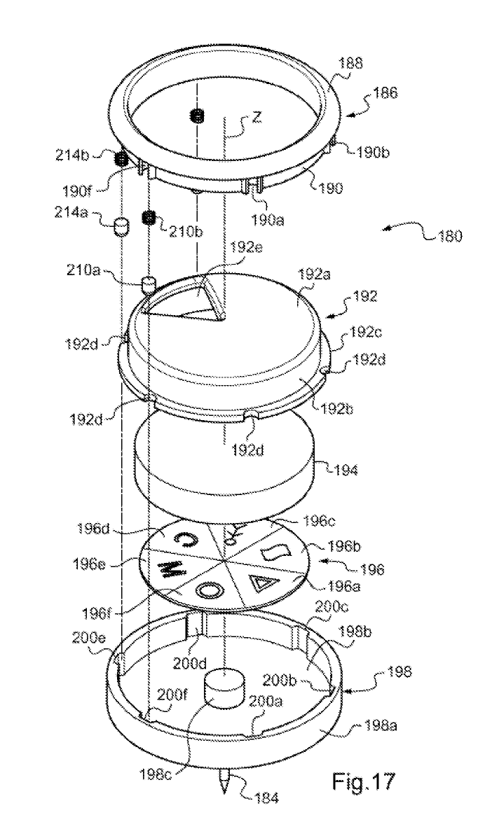

FIG. 17 is an exploded perspective view of the device from FIG. 16;

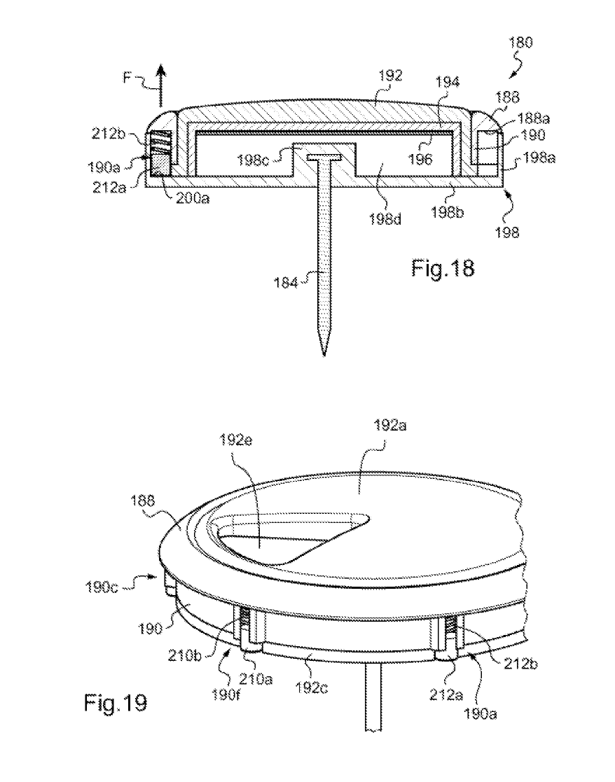

FIG. 18 is a diagrammatic view in axial section of the device from FIGS. 16 and 17;

FIG. 19 is a partial diagrammatic view showing the mechanism for preventing rotation of the display window;

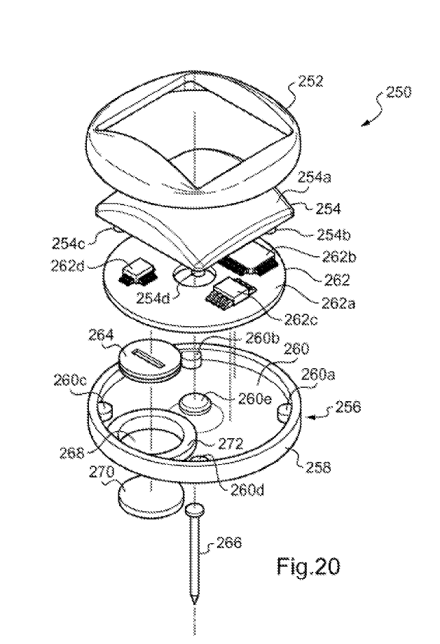

FIG. 20 is an exploded perspective view of a marking device of a protection system in accordance with a fourth embodiment of the invention.

As represented in FIG. 1 a device for marking a protection system against the theft of an article, for example a commercial article, in accordance with the invention and designated in a general manner by the reference 10 includes a head or casing 12 and a spike 14 that extends out of and away from the casing.

The housing 12 also includes a transparent window or cap 16 set into a peripheral frame 18 that has a central opening 18a to receive the transparent cap 16.

The frame or chassis 18 is mounted on a base 20 and is fixed to the latter by conventional mechanical means.

The spike 14 projecting relative to the external face of the base is fixed to its interior, for example.

FIG. 2 is an exploded view of the device from FIG. 1. The device thus comprises, starting from the top, the peripheral frame or chassis 18 with its central opening 18a, for example of square shape (the shape could equally be rectangular or even round or oval), in order to receive the transparent cap 16 having a perimeter of complementary shape so that it can be inserted in the opening 18a.

This cap serves as an information display area.

The cap has an upper surface 16a of convex shape and two opposite lateral faces 16b and 16c each including two openings. The convex or domed shape of the cap makes the device more compact.

In FIG. 2 only the openings in the face 16b are represented.

One of the openings 16d has a completely circular shape while the other opening 16e has a semicircular shape open on one of its sides to receive one of the two support members 22, 24 represented in FIG. 2, for example taking the form of rollers.

FIG. 3 represents the cap 16 in perspective from below and shows the second lateral face 16c with a completely circular opening 16f and a semicircular opening 16g on one of its sides.

The rollers 22 and 24 can therefore be inserted into the cap 16 thanks to the openings 16e and 16g.

Each of these rollers includes a respective longitudinal slot 22a, 24a through the substantially cylindrical roller, from one side to the other and over almost all its height, thus forming two half-cylinders.

Each roller also includes a respective head 22b, 24b projecting outside the cap 16.

FIG. 4 shows the longitudinal slot 22a and the head 22b of the roller.

Referring again to FIG. 2, the device 10 also includes a medium for information to be displayed produced for example in the form of an elongate tape or film of paper or other material that includes a plurality of printed information regions arranged side by side in the direction of the length of the tape.

In FIG. 2, two information regions 26a and 26b are disposed side by side.

The opposite ends of the tape 26 are inserted in the slots 22a, 24a of each roller and the tape is then wound around the latter in order to assume the position represented in FIG. 2.

In this position, the information medium 26 is wound around the two rollers 22 and 24, which are parallel to each other and spaced from each other.

Each of the rollers is able to turn about its longitudinal axis in order to spool the information regions of the tape 26 in front of the transparent cap 16 and more particularly the transparent upper face 16a (display window). The device 10 also includes means 38, 40 for turning the rollers. These means are motors, as will be explained later.

It is therefore clear that each of the rollers and the associated rotation means form selector means enabling selection of information on the medium 26 in order to display it in the display area (upper face 16a of the transparent cap).

Depending on whether one or the other of the rollers is driven in rotation, the tape moves in one direction (forward) or in the opposite direction (reverse).

It will be noted that if one or more items of information disposed in an information region are displayed via the transparent window 16a, the other information regions of the support are masked vis a vis the exterior and therefore not visible.

The device 10 includes a support part 28 having a curved general shape in its upper part 28a and having two rims 28b and 28c that partly close the bottom of the part, leaving an opening 28d between the rims.

The information medium 26 disposed around the rollers 22 and 24 is thus positioned on the part 28 and wound around the rims 28b and 28c so as to position the ends of the tape 26 wound around the rollers 22 and 24 inside the part 28 via the opening 28d.

When these components have been assembled, the assembly consisting of the medium 26 mounted on the rollers 22 and 24 and surrounding the rigid part 28 is installed in the cap 16 as represented in FIG. 5.

The marking device 10 includes a plate 30 positioned under the information medium (FIG. 2).

The plate 30 includes a central opening 32 and two lugs 30a and 30b.

The plate has dimensions corresponding to the size of the display window 16a.

As represented in FIG. 6, the lower face of the plate (which is not visible in FIG. 2) carries electronic components 34, 36 one and/or the other of which form(s) an electrical/electronic control system or circuit of the two motors 38 and 40. These components are FPGA type programmable components, for example, or preprogrammed circuits such as ASIC type circuits.

Alternatively, at least one of these components may include a microprocessor and one or more memories for storing various data and information.

As represented in FIG. 6 highly diagrammatically and in more detail in FIG. 7, each of the motors 38 and 40 is disposed along one of the edges of the plate 30. The two motors are therefore mounted parallel and head-to-tail along two opposite sides 30c and 30d of the plate 30. The motors are stepper motors, for example.

Each motor is placed with one of its ends against one of the lugs 30a, 30b which therefore serves as a support.

Each motor has at its opposite end a respective output shaft 38a, 40a that is threaded so as to mesh with the head of one of the corresponding two rollers 22, 24, which includes a toothed gear (FIG. 7).

Thus each motor is connected to a roller via a gear mechanism. Control of a motor is activated at one or more predetermined times programmed in a programmable clock 42 fixed to the plate 30 for example.

At one of these times, one of the components 34, 36 that forms a control circuit “awakes” and activates the motor concerned, i.e. causes it to operate. The motor activated in this way drives in rotation its threaded output shaft and thus drives this roller in rotation because it meshes with the gear of the corresponding roller.

The rotation of one of the rollers therefore causes movement of the tape (information medium) 26, which causes the printed images or information to scroll across the display window 16a.

One or the other of the motors 38, 40 is activated, which causes scrolling of the tape 26 in one direction of movement or the other.

The tape can therefore be wound onto or unwound from one of the rollers 22 and 24.

Activating the variable display of information from a programmed clock is described in more detail with reference to FIGS. 10 to 12.

It will be noted that for clarity the various electrical connections between the components on the plate 30 are not shown here.

Another, optional component not represented in the figure, for example also fixed to the plate 30, is for receiving information (an activation signal) communicated to the device 10 remotely, for example by radio waves or infrared beams.

This component is therefore a receiver appropriate for receiving information transmitted by one of these communication means or by other communication means not described above.

The external information received by the component in question enables activation of control of one and/or the other of the motors 38 and 40 as appropriate to the information. This other way of activating the variable display of information is used to activate selection means in a complementary way.

The component 44 fixed to the plate 30 (for example inserted in an open cylindrical housing of the plate that is not represented in the figure) represents a system for supplying electrical power to the various components and electrical/electronic circuits on this plate.

The component 44 is for example an electrical cell, for example of the button cell type.

This component 44 therefore supplies the electrical energy necessary for selecting information from the medium to be displayed via the transparent window (display window) of the cap 16.

As represented in FIG. 2, the marking device of a protection system in accordance with the invention includes the base 20 a central portion of which is open and delimited by a first internal rim 50.

The cap 16 that encloses the information medium 26 and the support part 28 and is mounted on the plate 30 is arranged in the central part 20a of the base, likewise the motors 38, 40.

It will be noted that the perimeter of the cap 16 has a substantially square shape such that, once housed inside the central part 20a of the base, the cap defines between each of its lateral faces and the internal edge 50 of the base a space for accommodating a motor and the head of one of the rollers.

The open central portion 20a has at its center a projecting area 20b in which the head 14a of the spike 14 is disposed (FIG. 9).

This projecting area 20b enters the opening 32 in the plate 30 when the latter is installed at the bottom of the housing delimited by the rim 50.

It will be noted that the lugs 30a and 30b of the plate cooperate with respective grooves in the rim 50 in order to prevent rotation of the plate.

As represented in FIG. 2, the central portion 20a of the base also includes a projecting area 20c eccentric relative to the central area 20b and having an opening through it to accommodate the cell 44 from FIG. 6.

Moreover, as represented in FIG. 8, a cover 54 closes the opening 20c which in the absence of the cover normally opens onto the lower face of the base 20.

This cover 54 includes a notch 54a enabling this cover to be turned and the cell 44 replaced if necessary.

The base 20 also includes an external rim 56 defining with the internal rim 50 an annular space 58 around the central area 20a (FIGS. 2 and 9).

This annular space receives one or more passive units that are adapted to receive electromagnetic waves from a security/detection (antitheft protection) system outside the device of which the protection system including the device is part.

Thus when an article sold in a store and to which the device 10 is fixed by means of the fixing means 14 comes near a transmitter of electromagnetic waves, the passive unit 60 receives those waves, thus triggering an alarm.

For example, the passive unit or circuit 60 is a resonant circuit for example which resonates when electromagnetic waves impinge on it and thus triggers an alarm signal on passing a security portal including the transmitter. This portal is installed in a point of sale (store) selling the article to be protected or in premises in which the article is displayed.

It will be noted that the space 58 reserved in the base 20 enables remote siting of the active or passive units of the marking device relative to the location of the motors and their control electronics.

Remote location of the active or passive units or circuits prevents interference with the detection of the device on passing a security portal in a store in the presence of the motors.

Alternatively, if there is no motor in the marking device, the active or passive detection units or circuits may be located elsewhere in the device. The device can therefore be more compact.

FIG. 10 shows the system for processing the mode of activation of the variable display using a programmable clock.

The components shown in FIG. 10 have already been described with reference to the previous figures.

This system therefore includes the electrical power supply system (energy supply system) 44, the programmable clock 42, a control system or circuit 34 or 36, a motor 38 or 40, a gear mechanism 40a, 22b and an information medium 26, here represented in the form of a tape mounted on the support members 22 and 24 (represented here in the form of rollers).

The combination of the information medium 26 and its support members 22 and 24 is represented diagrammatically enclosed inside a casing 70 of a marking device in accordance with the invention.

A portion 72 of the casing constitutes a display window for viewing information on the support that has been selected.

When applying a marking device or a protection system including a marking device in accordance with the invention to an article for sale to be marked and/or to be protected (or prior to this fitting operation), the clock 42 is programmed in order to select the corresponding information, for example the corresponding image or images to be displayed at one or more given times, as a function of a predefined schedule.

For example, the clock is therefore programmed to select the display of a first image corresponding to a first mark-down, the image representing for example the information “−20%” printed on a yellow background and which will be selected on 15 January.

A second image corresponding for example to a second mark-down represents the information “−30%” printed on an orange background and which will be selected on 25 January.

A third image will for example be selected on 5 February and corresponds to a third mark-down, bearing the information “−50%” printed on a red background, and so on.

The selection and therefore the changing of the images is effected by activating the motor or motors 38/40 via the control system or circuit 34 or 36 at a predefined time on a predefined date for a relatively short time interval.

This control system or circuit includes a wake-up circuit which receives a pulse from the clock at a predefined time and date, thus activating said control system or circuit.

Alternatively, the wake-up circuit is incorporated in the clock.

The motor or motors, which here are stepper motors for example, are therefore awoken at the predefined time and date programmed in the clock 42 and drive the tape or film 26 via a gear mechanism 40a, 42b in the case of the motor 40 in FIG. 2.

Various images have previously been printed on this tape and, by rotating the members 22 and 24, the tape is scrolled across the window 72 and stops when the selected image is facing this window, i.e. in the display area.

In the example represented in FIG. 10 the image bearing the information “−20%” has been selected by the programmed clock and the control circuit that acts on the motor or motors to cause them to function (to be more precise to cause their output shaft to turn) appropriately for the tape 26 to move as required and position the image to be displayed corresponding to the predefined date and time.

Generally speaking, the tape is unwound on one side (at one end of the tape where one of the members 22 and 24 is located) to be rewound on the other side (at the opposite end of the tape where the other member is located) and causes the selected image to appear in the display or viewing area.

It will be noted that the images may be printed on the medium 26, which may be made of paper or plastic.

All printing techniques may be envisaged. In particular, hologram or lenticular printing technologies can be used to print information (images and/or text and/or photographs, etc.) on a medium. Lenticular imaging is a technology enabling the production of images giving an impression of relief (3D) or changing as a function of the viewing angle.

Alternatively, the images or more generally the information carried by this tape may be fixed thereto differently, for example by etching it.

Outside the times or time references at which images are selected, the electrical and mechanical control part (control circuit 34 or 36 and motors 38 and 40) is dormant and therefore does not consume energy.

Only the clock 42 consumes current, therefore saving a considerable amount of energy.

For example, an electrical power supply system includes one or two “button” type cells, for example of the “SR62/SR516/315” type, weighing approximately 0.7 grams, having a diameter of 5.8 mm and a capacity of 20 mA-hour.

Such cells are generally used in electronic wristwatches.

The clock 42 is for example a quartz clock such as that of a watch and consumes less than 0.8 mA at an electrical voltage of 1.55 V.

Given these two components (cell and clock), the marking device is small and light and has a service life of more than one year.

FIG. 11 is a view to a larger scale of the right-hand end of the processing system represented in FIG. 10 and shows the movement of the tape 26 the printed images on which scroll across the display or viewing window 72.

FIG. 12 represents to a larger scale the tape 26 on which is printed a plurality of images that can be selected automatically by the clock 42 thanks to the built-in control circuit 34 or 36. This circuit knows the time and the date supplied by the clock and therefore selects a given image on the strip at a predefined time and date.

In one embodiment, the tape or film 26 may contain approximately seven printed images, which represents an acceptable weight/size ratio for a marking device in accordance with the invention.

This tape or film may be changed in order to install in the device a new tape or film carrying new images. It is for example changed when the device is already fixed to an article without it being necessary to detach it therefrom.

The tape or film can therefore be replaced like a consumable without it being necessary to replace the whole of the device to change the information to be displayed by said device.

The tape or film carrying the information to be displayed may be mounted on a support made from plastic material, for example.

The tape or film mounted on this support is therefore similar to a toner cartridge in a printer, for example, or a gelatin silver photographic film.

It will be noted that the support members or rollers 22 or 24 described above with reference to the previous figures are part of the interchangeable support.

These members may take another form, for example.

FIG. 13 shows very diagrammatically and partially a device in which the tape or film and its support are interchangeable.

The device 70 resembles the device of the first embodiment in that it includes a transparent cap 72 set into a peripheral frame 74 and mounted on a base 76.

As in the device from FIGS. 1 and 2, the parts 74 and of the casing are fixed to each other or may alternatively be made in one piece.

Similarly, the part forming the frame 74 serves to hold the cap or window 72 in position.

The means for fixing the device to an article also take the form of a spike 78 that extends from the lower ace of the base 76.

To be more specific, this spike is fixed into a raised central portion 76a of the base.

The cap 72 encloses the combination formed by a support 80 for information to be displayed, for example produced in the form of a printed tape such as the tape from the previous figures, wound around support members or rollers 82 and 84 and mounted on a support part or support 86.

The tape wound at each of its two opposite ends on one of the rollers 82 and 84 covers the support part or support 86, therefore enclosing the latter.

As represented in FIG. 13, the combination formed of the information support 80, the support part or support and the members 82 and 84 is enclosed inside the internal cavity of the cap 72.

This combination rests on the internal face of the base 76, in its recessed central area, more particularly around the raised area 76a.

For clarity, the motors 38 and 40 are not represented in this figure, likewise the passive unit or circuit 60 imparting to the device an antitheft protection function.

It will be noted that the cap 72 must be removed first if the information support 80 has to be changed.

In a variant embodiment, a marking device may include, instead and in place of the motors and the tape carrying information, a digital display screen and means for storing information such as images, which may be an electronic memory for example.

As a function of the predefined schedule (predefined date and time) that has been programmed in the programmable clock 42, the control system or circuit 34 or 36 fetches the data or information contained in the memory to transfer it to the digital display screen for display.

The marking device or devices in accordance with the invention described with reference to the previous figures may also include an active or passive RFID chip, for example for identifying the device (or security tag) in order to be able to reprogram it (thanks to this chip the device may be electronically associated with the article to which it is fixed) and to trace the article to which the device is fixed in conjunction with systems for interrogating the RFID chip that are present in the store, for example.

FIGS. 14 and 15 show two different types of system for protecting an article against theft.

Each system includes a device in accordance with the invention for marking the article.

Each of the devices is for example the device 10 or 70 from the previous figures, or even some other device.

It will be noted that the devices from FIG. 16 and the subsequent figures are also part of a system for protecting an article against theft.

The protection system 150 therefore includes such a marking device and a complementary device 152.

This complementary device includes a body 154 of substantially hemispherical shape having a substantially plane face 156 located in an equatorial plane.

An opening 158 in the face 156 enables insertion of a spike 14 or 78, depending on the marking device.

In a known manner, the body 154 encloses means for locking the spike when the latter has been inserted in the body.

Diagrammatically represented in dashed line is an article 160, for example an article that is for sale, for example a garment (only part of the garment is represented), through which the spike of the marking device (means for fixing the device to the article) has been passed before the latter is assembled with its complementary device 152.

FIG. 15 shows a system (170) for protecting articles against theft of another type in which the marking device is identical to the previous device but the complementary device 172 is different.

This device in fact takes the form of a thick plate substantially plane on one of its faces 172a and having a protuberance 174 on the opposite face 172b.

The upper face 172a includes an orifice for inserting the spike of the marking device and the cooperation of the two parts of the two devices constituting the protection system is identical to that described previously.

In accordance with a variant that is not represented, the complementary device of FIG. 14 or 15 includes one or more active or passive units adapted to transmit electromagnetic waves to the exterior of the device or to receive same, thus cooperating with an external system such as a security portal in premises (point of sale, museum, etc.) in order to detect the presence of the protection system near the external system. The unit or units are for example a unit such as the unit 60 from FIGS. 2 and 9 and here function in exactly the same way as what is described with reference to those figures. It will be noted that in accordance with another variant that is not represented a plurality of active or passive units may be divided between the two devices in order to increase the reliability of detection (e.g. in the event of failure of a unit).

FIG. 16 shows another embodiment of a marking device of a system in accordance with the invention for protecting an article against theft.

The device 180 is represented once assembled and takes the form of a casing or a head 182 that includes a spike 184 extending out of the casing.

The casing forms an open housing to receive a medium carrying information to be displayed, as shown in detail in the subsequent figures, and an element including an area for displaying information from the medium that is disposed on the casing so as to close the housing.

FIG. 17 represents an exploded respective view of the device 180.

Thus the device includes, starting from the top, an annular ring 186 pierced in its central part, including a flange 188 forming a rim extending radially and a skirt 190 extending axially.

The device also includes a cap or cache 192 having a front upper wall 192a, an annular axial wall 192b extending axially, substantially perpendicularly to the front wall 192a.

The free edge of the wall 192b opposite that in contact with the wall 190a includes a flange or rim 192c extending radially outward from the cache or cap 192. The flange includes a plurality of outwardly facing notches 192d.

Moreover, the front wall 192a includes an opening 192e which here has the shape of an angular sector, for example.

It will be noted that the opening 192e serves as a display window in the sense in which this term is used in connection with the invention.

The device 190 further includes a transparent element 194 forming a dial or glass.

This element has the shape of a cylindrical cup closed at one end, open at the opposite end and disposed in an inverted position in FIG. 17.

The shape and the dimensions of this element 194 are such that it can be inserted inside the cache 192.

The device 180 includes a medium (e.g. a disk) 196 carrying information to be displayed bearing on one face (the upper face visible in FIG. 17) a plurality of printed information regions 196a-d (images, photographs, texts, logos, etc.) that are arranged side by side in different angular sectors of the face of the disk. Each region is the shape of an angular sector, for example.

The opening 192e and the information regions can have other shapes, however.

This disk has dimensions that enable it to be inserted inside the open housing formed in the element 194.

As will emerge hereinafter, in the embodiment described the cache 192 is able to turn about its center, which is located on a longitudinal axis Z, in order for the opening or window 192e to be positioned in geometrically corresponding relationship with one of the information regions on the disk 196. This arrangement therefore makes it possible to view information from the region selected in this way through this opening (information display area).

In accordance with a variant that is not represented, the glass or dial 194 may be omitted and the cache 192 modified so that the opening 192e is closed and made from a transparent material. The rest of the front wall 192a is made from an opaque or at least non-transparent material.

The information areas are therefore protected by the cache or cover and the information to be displayed is still selected by rotating the cache.

The device 180 also includes a base 198 having the general shape of a cup open at the top and including a cylindrical wall 198a extending perpendicularly to a bottom wall 198b. The bottom wall has in its central part a portion raised relative to the bottom wall.

This raised portion 198c accommodates the head of the spike 184.

The information medium 196 may be positioned on this portion 198c or fixed to the lower face of the transparent dial 194 as represented in FIG. 18 (which is an axial section of the device).

This figure shows the various elements that have just been described assembled to one another, the dial therefore enclosing the medium 196 and the dial itself being inserted into the cap 192.

There is an annular housing 198d inside the base and the dial, for example for housing therein an active or passive unit able to emit electromagnetic waves or to receive same coming from a complementary security/detection system external to the device 180.

The base 198 includes on the internal face of its cylindrical wall 198a a plurality of regularly spaced axial grooves 200a-f.

The number of grooves corresponds to the number of information regions carried by the medium 196.

Similarly, the number of notches 192d corresponds to the number of information regions.

Moreover, the axial extension 190 of the ring 186 has on its exterior face a series of axial housings 190a-f regularly distributed at the periphery of the skirt 190 that are partially open thanks to the presence of an axial slot (FIG. 19). The number of housings (for example six housings) corresponds to the number of information regions or zones.

The shape of this housing corresponds for example to a half-cylinder forming an excrescence on the external face of the skirt 190 and open in the axial direction.

These assembly members are represented in FIGS. 18 and 19 when assembled inside the respective housings referred to above and in FIG. 17 before assembly.

The vertical lines in FIG. 17 show the bringing into geometrically corresponding relationship of the various elements cooperating with these assembly members.

These assembly members therefore constitute pairs each comprising on the one hand a pin, for example the pins 210a, 212a, 214a, and on the other hand an elastic member, for example a spring, such as the springs 210b, 212b and 214b.

Because of the action of the compression elastic element, the pins are held in part in a position located outside the housing (for example the housing 190f in the case of the pin 210a) and are therefore inserted in the notches 192d provided for this purpose on the outside of the cache 192.

These assembly members disposed in part inside their housing are inserted in the grooves provided in geometrically corresponding relationship inside the base 198.

A pair of assembly members inside the groove 200a is represented in FIG. 18.

It will be noted that the elastic members bear on the one hand on the pin and on the other hand on the lower face 188a of the flange 188.

Such an arrangement prevents the cache 192 from rotating.

An unintended user seeking to modify the display of the device 180 is therefore unable to do so.

To modify the display and thus to select another information region facing the opening 192e one or more motors are employed to rotate the dial 194 and the disk 196 to which it is fixed or the disk alone via a simple gear mechanism of the type shown in FIG. 7. For clarity the programmable clock, the control circuit of the motor or motors and the electrical power supply system are not represented.

It will be noted that the dial 194 may alternatively carry the information (printed images), in which case the disk is dispensed with.

If it is required to replace the disk 196 and the dial 194 to which it is fixed (or the dial alone if the disk is not present or the disk alone if the dial and the disk are independent of each other), an authorized user, such as a member of the staff of a store in which an article to which such a device is fixed is sold, removes the ring 186 and the cache 192 to access the dial 194 and the disk 196 (if the latter is present).

In the exceptional case where it is required to select manually another information region in order to display it, the user proceeds as follows. They position over the device a magnet sufficiently powerful to exert on each of the pins (210a, 212a, 214a, etc.) a vertical upward attraction force (along the arrow F in FIG. 18), therefore compressing the elastic element disposed over the pin sufficiently for the pin to enter completely inside the corresponding housing and therefore to exit the corresponding notch 192d of the cache.

Manual rotation of the latter is then possible and enables the display window 192e to be brought into geometrically corresponding relationship with the required information region.

It will be noted that the mechanism enabling rotation of the cache 192 is optional and additional to the main mode of activation of the variable display of information.

The invention therefore covers a device not including this optional mechanism.

FIG. 20 shows another embodiment of a marking device of a system in accordance with the invention for protecting an article or product against theft.

The device 250 includes a peripheral frame or chassis 252 including a central opening of substantially square shape passing completely through the chassis. This opening is intended to receive an information medium 254 of substantially complementary shape having a convex upper face 254a facing toward the outside of the device.

This information medium takes the form of a digital display screen, for example, of the LCD type, for example.

This medium includes four feet of which only three 254b, 254c, 254d are represented in the figure.

As represented in FIG. 20, a base 256 in the form of a cup open at the top includes an axial annular wall 258 and a bottom wall 260 as well as a plurality of studs 260a-d the number of which corresponds to the number of feet of the information medium 254 and which are arranged at the corners of a square for example.

These studs are used to locate the medium and also to fix it to the base, for example.

Furthermore, the device 250 also includes a plate 262 disposed between the medium 254 and the base 256 that has various elements or components on one of its faces, for example the upper face 262a. To be more specific, the face 262a carries various electronic components 262b, 262c and 262d that may be application-specific integrated circuits (ASIC), microprocessors and memories, programmable components of the FPGA type, for example.

The component 262b is a control system or circuit for selecting information to be displayed on the screen 254. The component 262c is a programmable clock that has been programmed in accordance with a predefined schedule as described above and the component 262d is a ROM type memory for example that contains a list of the information to be displayed (images, photos, etc.). For clarity none of the electrical connections between the various components have been represented.

The plate 262 has the general shape of a disk, for example. As a function of the occurrence of a date and a time programmed in the clock, the circuit 262b connected to the clock then consequently commands display on the screen 254, extracting from an area of the memory (storage means) 262d information that is to be displayed and is stored therein (the circuit 262b knows the address at which the information is stored in the memory) and supplying this information to the screen in order for it to display it. This new information replaces the information already present on the screen or fills the screen that is on standby, as appropriate.

A cell or battery 264 is provided as an electrical power supply system for the various electrical components and circuits referred to above.

This cell comes into contact on the lower face of the disk 262 opposite the face 262a with electrical tracks and contacts for supplying the necessary power to the various components.

The base 256 also includes in the bottom wall 260, on the one hand, a raised central portion 260e intended to accept the head of a spike 266 for fixing the device 250 to an article for sale to be protected and, on the other hand, an opening 268 through the bottom wall 260.

This opening opens onto the lower face of the base 256 and has in its internal portion a threaded portion for screwing on/unscrewing a cover 270 that closes this opening.

The opening 268 is flanked by an annular ring 272 inside which the cell 264 is housed.

It will be noted that the various marking devices that have just been described all include a spike as the means for fixing the device to an article or product to be projected against theft, for example an article that is for sale (or the packaging containing the article).

However, such fixing means (a spike) may be provided in the complementary device with which the marking device cooperates to form a combination for protecting an article against theft.

In this case, the means for fixing it to the article with which the device will be associated are carried by the complementary device.

Furthermore, when the marking device in accordance with the invention is associated with a complementary device, one or both of these devices include(s) one or more active or passive units able to emit electromagnetic waves or to receive same from a source external to the device.

Once again, various arrangements of the two devices are possible, combined with the presence of fixing means in one or the other of these devices.

In accordance with another variant embodiment that is not represented, the system for protecting an article against theft including a marking device in accordance with the invention includes other types of means for fixing it to an article to be protected that do not necessitate perforation of the article or the packaging containing the article (for examples shoes, eyeglasses, even articles or packages the materials of which are too hard or to fragile to have a spike passed through them).

These may be clamping/unclamping members for example, produced for example in the form of a clamp the two jaws of which can be moved toward each other or away from each other by a control member on the marking device.

The device of the protection system therefore constitutes a single part that carries all the elements necessary for fixing it to the article to be protected against theft or the packaging containing the article.

The control member may be a thumbwheel or a knob, for example, that is turned to move the clamping members toward or away from each other according to the required movement. An internal mechanism connects the control member to the clamping members.

Such members are described in the international application PCT/FR2010/050400 filed 9 Mar. 2010.

In accordance with a further variant that is not represented, when the means for fixing the marking device of a protection system to an article take the form of a spike, the latter can penetrate further inside the device than is shown in FIGS. 1 to 20. The spike may therefore be fixed not to the base of the latter but to one of the elements disposed above it, such as the information display window, for example, or even an intermediate element between the latter and the base.

1. A device for marking an article to identify it, the device including an information display area, a medium (26) for information to be displayed, an electrical power supply system (44), means (38, 40, 40a, 22b) for selecting information from the medium to display it in the display area and means for fixing the device to the article or its packaging, characterized in that the device includes at least one programmable clock (42), said selection means being adapted to be activated at one or more times programmed in the programmable clock.

2. The device as claimed in claim 1, characterized in that it includes a control circuit (34, 36) that activates the means for selecting information from the medium at the predetermined time or times.

3. The device as claimed in claim 1, characterized in that the information medium is a medium including a plurality of printed information regions, the information selection means being adapted to be activated to select one or more information regions to be displayed in the display area.

4. The device as claimed in claim 1, characterized in that the medium is an elongate tape (26) comprising a plurality of printed information regions arranged side by side in the lengthwise direction of the tape, said tape being wound around two spaced members (22, 24) each of which is adapted to turn about its longitudinal axis to scroll information regions of the tape in the display area.

5. The device as claimed in claim 4, characterized in that the tape is interchangeable.

6. The device as claimed in claim 1, characterized in that the medium is a disk (196) having on one face a plurality of printed information regions arranged side by side in different angular sectors of the face of the disk.

7. The device as claimed in claim 6, characterized in that the disk is able to turn about its center to bring into geometrical corresponding relationship information regions and the information display area.

8. The device as claimed in claim 6, characterized in that a cache (192) is positioned over the disk and includes an opening facing an information region to be displayed.

9. The device as claimed in claim 8, characterized in that the cache (192) is able to turn about its center so that the opening is brought into geometrically corresponding relationship with an information region to be displayed.

10. The device as claimed in claim 1, characterized in that the selection means include at least one motor (38, 40) connected to the information medium.

11. The device as claimed in claim 10, characterized in that said at least one motor is connected to the information medium via a gear mechanism (40a, 22b).

12. The device as claimed in claim 10, characterized in that said at least one motor is a stepper motor.

13. The device as claimed in claim 1, characterized in that the information display area is a digital display screen (254).

14. The device as claimed in claim 1, characterized in that the electrical power supply system includes at least one cell (44).

15. The device as claimed in claim 1, characterized in that the device includes an information display window at least a portion of which window is transparent and constitutes the information display area so that selected information from the medium is visible through said at least one transparent window portion.

16. The device as claimed in claim 1, characterized in that the marking device includes a casing forming an open housing to receive the information medium.

17. The device as claimed in claim 16, characterized in that the display window is disposed on the casing so as to close the housing.

18. The device as claimed in claim 17, characterized in that the marking device includes a spike (14) extending out of the casing.

19. The device as claimed in claim 18, characterized in that the window is disposed with one of its faces referred to as the internal face facing a face referred to as the internal face of the information medium carrying information, the spike extending from the internal face of said window in the direction of the internal face of the medium and passing through the latter in order to project relative to a face called the external face of the medium externally of said medium.

20. The device as claimed in claim 18, characterized in that the device includes a head having two opposite faces, an internal face and an external face from which the spike extends, the information medium being disposed between the internal face of the head and the display window.

21. The device as claimed in claim 1, characterized in that the marking device includes at least one active or passive unit that is able to emit electromagnetic waves toward the exterior of the device or to receive same, therefore conferring on the device a function of protecting the article against theft and/or a function of identification and/or traceability and/or storage or exchange of information.

22. A system for protecting an article against theft, characterized in that it includes the device as claimed in claim 1 for marking the article.

23. The protection system as claimed in claim 22, characterized in that it includes a complementary device and means for assembling the two devices with each other and locking them in the assembled position.

24. An article equipped with the marking device as claimed in claim 1.
